(19) United States
(12) Patent Application Publication
(10) Pub. No.: US 2017/0031908 A1
(43) Pub. Date: Feb. 2, 2017

(54) EFFICIENT PARALLEL INSERTION INTO AN OPEN HASH TABLE

(71) Applicant: Futurewei Technologies, Inc., Plano, TX (US)

(72) Inventors: Xian LIU, Sunnyvale, CA (US); Mark KAMPE, Los Angeles, CA (US)

(21) Appl. No.: 14/813,582

(22) Filed: Jul. 30, 2015

(51) Int. Cl. G06F 17/30

(52) U.S. Cl. CPC G06F 17/3033

(57) ABSTRACT

Methods and apparatuses for servicing parallel requests to an open hash table are disclosed. A memory is used for storing a plurality of sub-tables, and a processor coupled to the memory that receives the incoming request which includes a key value to perform a first action in a first sub-table, calculates a routing hash value associated with the key value using a hash function, determines an index for the routing hash value by calculating a modulo (N) function of the routing hash value, and appends the incoming request to a queue associated with the first sub-table, wherein N is a number of sub-tables associated with the processor, the index corresponds to the first sub-table, and the processor is operable to retrieve the incoming request from the queue to perform the first action.

### FIELD

Embodiments of the present invention generally relate to the field of electronic storage systems. More specifically, embodiments of the present invention relate to high performance data management using open hash tables.

### BACKGROUND

High performance systems typically manage large amounts of data, often including millions of individual items. Designing indices to keep track of the information is critical to the performance of these systems. The process of locating or deleting existing items or adding new items must be very efficient in both access time (e.g., read time and write time) and required storage space in memory.

A standard way of managing large numbers of independent data items is with hash tables. One familiar with the art will know that the most common implementations of hash tables are linked lists and open hash tables. High performance systems often need to service multiple look-up, insertion and deletion operations in parallel. One familiar with the art will understand that maintaining the integrity of a hash table in the face of parallel operations generally requires some form of serialization.

Linked list hash tables are generally implemented as an array of list headers. A hash function maps an item key into an index into this array (often called a hash bucket). The header points to a linked list of items that hashed into this “bucket”. Serialization is generally accomplished by adding a lock to each header. That lock protects all operations within that list. Each operation requires only a single lock, potentially keeping overhead low. If the number of list headers is much larger than the number of parallel requestors, the probability of conflict will be low and the parallelism will be high. There are, however, a few problems with linked list hash tables. Searching long lists can be time consuming, and the linked list pointers can significantly increase the required memory. These problems are well-addressed by open hash tables.

For an Open hash table, the item key is mapped into an initial location, which might contain the desired item. But if multiple keys map to the same initial location, there will be a collision followed by an overflow search. There are numerous well known algorithms for conducting overflow searches, but they all involve looking at successive entries in a well-defined order. Unfortunately, it is much more difficult to serialize insertions into an open hash table. Overflows and secondary overflows may involve numerous cells, and parallel operations may cause dead-locks. Obtaining and releasing a large number of locks greatly increases the execution costs for an open hash table. Adding locks to each cell uses almost as much memory as the pointers in a linked list. These issues limit the use of open hash tables in applications that must support parallel insertions. What is needed is a technique that offers the performance and efficiency of open hash tables while supporting parallel operations without the need for locks.

### SUMMARY

The present disclosure provides the performance and efficiency of open hash tables while supporting parallel operations without the need for locks. It does so by partitioning a single open hash table into multiple independent sub-tables.

According to one approach, an apparatus for servicing requests to an open hash table using sub-tables is disclosed. The apparatus includes a memory for storing a plurality of sub-tables, and a processor coupled to the memory that receives the incoming request which includes a key value to perform a first action in a first sub-table, calculates a routing hash value associated with the key value using a hash function, determines an index for the routing hash value by calculating a modulo (N) function of the routing hash value, and appends the incoming request to a queue associated with the first sub-table, where N is a number of sub-tables associated with the processor, the index corresponds to the first sub-table, and the processor is operable to retrieve the incoming request from the queue to perform the first action.

According to another approach, a method of servicing requests to an open hash table using sub-tables is disclosed according to embodiments of the present invention. The method includes receiving the incoming request comprising a key value, calculating a routing hash value associated with the key value using a hash function, determining an index for the routing hash value by calculating a modulo (N) function of the routing hash value, where N is a number of sub-tables associated with the request router and the index corresponds to a sub-table, appending the incoming request to a service queue associated with the sub-table, retrieving the incoming request from the service queue, and performing an operation requested by the incoming request in the sub-table.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary single computer system architecture upon which embodiments of the present invention may be implemented.

FIG. 2 is an illustration of an exemplary request router 201, partition managers 204A and 204B, and sub-tables 205A and 205B, where the request routers are in the same computer system as the partition managers according to embodiments of the present invention.

FIG. 3 is a block diagram illustrating two exemplary computer systems, a client and a server, according to embodiments of the present invention.

FIG. 4 is a detailed illustration of an exemplary request router 401, partition managers 404A and 404B, and sub-tables 405A and 405B depicted according to some embodiments of the present invention where request routers are on different computers or in different address spaces than partition managers.

FIG. 5 is a flow chart illustrating an exemplary sequence of computer implemented steps for servicing parallel requests according to embodiments of the present invention.

FIG. 6 is a flow chart illustrating an exemplary sequence of computer implemented steps for servicing parallel requests to an open hash table delivered inter-process or network messages using a request router according to embodiments of the present invention.

FIG. 7 is a flow chart illustrating an exemplary sequence of computer implemented steps for adding a partition manager according to embodiments of the present invention.

FIG. 8 is a flow chart illustrating an exemplary sequence of computer implemented steps for redistributing sub-tables in response to the failure or shut-down of a partition manager according to embodiments of the present invention.

FIG. 9 is a flow chart illustrating an exemplary sequence of computer implemented steps for performing load balancing using a partitioned open hash table according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

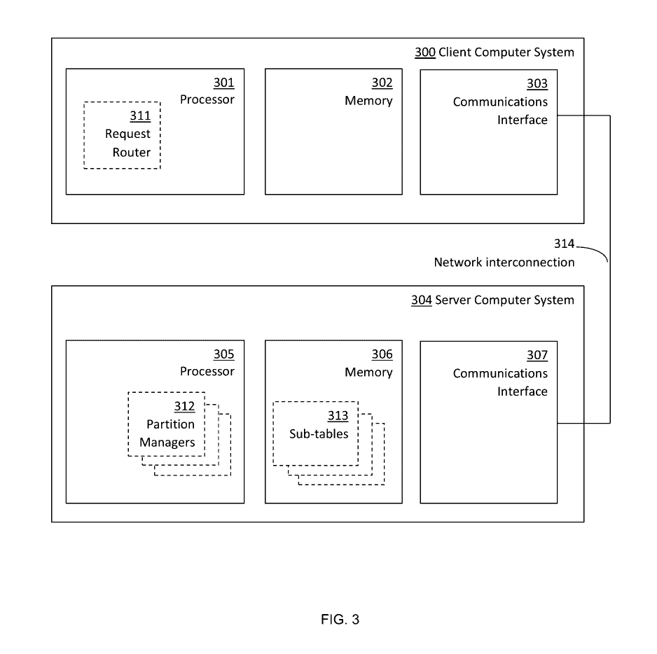

Portions of the detailed description that follows are presented and discussed in terms of a method. Although steps and sequencing thereof may be disclosed in a figure herein describing the operations of this method (such as FIG. 3), such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices, such as computer system 100, typically include at least one processor 101, and some amount of memory 102. Computer system 100 may also include communications devices (e.g., Communications Interface 103). Memory 102 may include volatile and/or nonvolatile, removable and/or non-removable media implemented in any method or technology for storage of information such as computer readable instructions, data structures, program modules, or other data. Memory 102 may comprise RAM, ROM, NVRAM, EEPROM, flash memory or other memory technology. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of communications media.

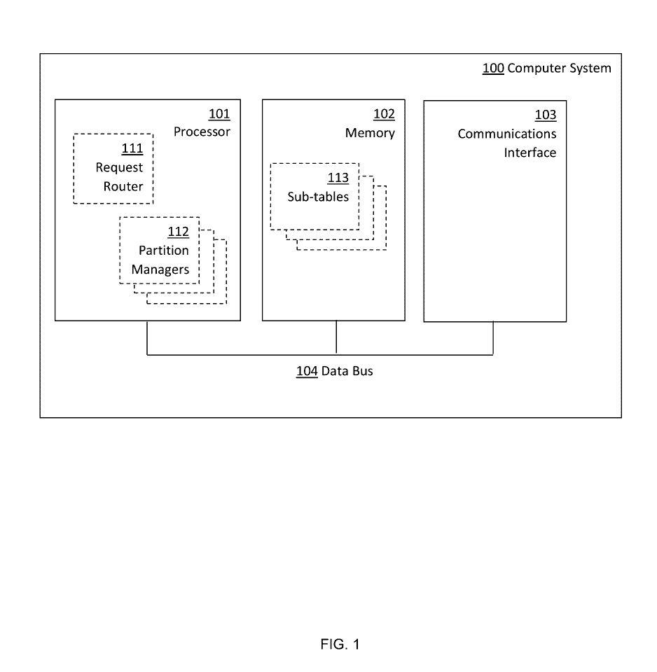

With regard to FIG. 1, an exemplary single computer system architecture 100 upon which embodiments of the present invention may be implemented is depicted and comprises a central processing unit (CPU) 101 for running software applications and optionally an operating system. Memory 102 stores applications and data for use by a processor (e.g., Processor 101). Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

With regard still to FIG. 1, a communication or network interface 103 allows the computer system 100 to communicate with other computer systems via an electronic communications network, including wired and/or wireless communication and including an Intranet or the Internet, according to embodiments of the present invention. Components of computer system 100, such as CPU 101, memory 102, and communications interface 103, may be coupled via one or more data buses 104. Processor 101 executes software for receiving incoming requests and routing requests to an appropriate service queue, including request router 111 and partition managers 112. Request router 111 and partition managers 112 are computer executable instructions that are executed by the processor to perform certain functions. For example, incoming requests may be received by request router 111 and queued for operation by a partition manager 112 using one or more service queues. A partition manager 112 executed by the processor may be configured to perform operations (e.g., lookup, insertion, and delete operations) on one or more open hash table (e.g., sub-tables 113). Sub-tables 113 are stored in Memory 102.

Embodiments of the apparatuses disclosed herein include a request router and multiple partition managers executed by a processor. The request router receives requests, determines which partition it belongs in, and queues that request for service by the appropriate partition manager. The partition managers services requests (e.g., locate, insert, or delete entries from the hash table) and performs the requested action one at a time. Where all operations in a particular partition (sub-table) are performed by a single partition manager, there is no possibility for conflicting operations. As long as the number of partitions is greater than or equal to the maximum desired parallelism (number of requests that can be processed at a single time), serialization through the partition managers will not become a bottle-neck request router.

A request router executed by a processor determines which partition a particular request belongs in by computing a deterministic function on the request key. The most obvious approach is a simple hash (polynomial function of the bytes in the key, modulo the number of partitions). In another approach, the simple hash is used to index into a redirection table, whose entries specify which partition manager should service these requests. Adding a level of indirection makes it easier to adjust the assignment of sub-tables to partition managers for load balancing, failure, or the addition of new partition managers.

There are many approaches to implementing the partition managers. Depending on the required hash table size, performance, scalability, and availability requirements, partition managers can be implemented in distinct nodes on a network, distinct CPUs in a multi-processor system, distinct cores in one or more multi-core CPU, distinct processes, or any other mechanism that can support multiple independent logically sequential execution sequences.

There are also multiple approaches to implementing the passing of requests from the request router to the partition managers. If the service and partition managers operate in a shared address space the queues can be implemented with standard in-memory data structures. If the service and partition managers share a common file system that supports message queues, operation requests can be delivered through those files. If the service and partition managers do not share an address space or file system, operations can be forwarded from the request router to the partition managers as inter-process or network messages.

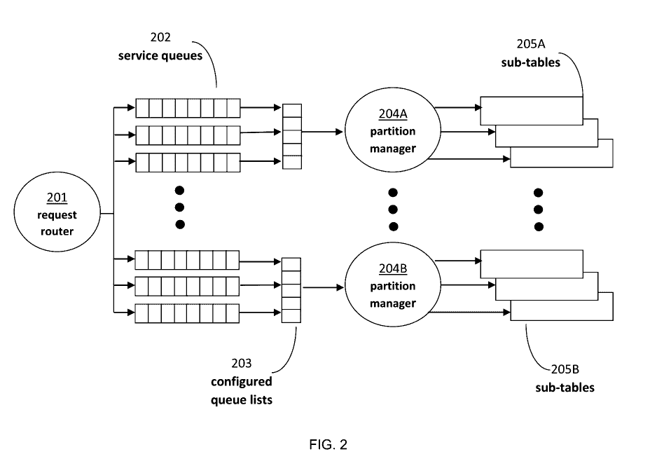

With regard to FIG. 2, a detailed illustration of an exemplary request router 201, partition managers 204A and 204B, and sub-tables 205A and 205B are depicted according to embodiments of the present invention. Service queues 202 are associated with one or more sub-tables (e.g., sub-tables 205A). One familiar with the art will recognize there are numerous well-known ways to implement a queue for service requests with in-memory data structures or by exploiting message queueing mechanisms within the operating system or file system. Request router 201 determines which sub-table a particular request belongs in and adds that request to an associated queue (e.g., a service queue of service queues 202). A partition manager (e.g., partition manage 204A) serves one or more sub-tables (e.g., sub-tables 205A). A configured queue list 203 is used to specify which queues are served by which partition manager. According to some embodiments, the configured queue list 203 comprises a global or per partition manager configuration table. A particular sub-table is served by one partition manager at a given time. This ensures the serialization of all operations within that sub-table. As long as the number of partition managers is greater than or equal to the desired number of concurrent operations, serialization will not limit the parallelism of execution.

With regard to FIG. 3, two exemplary computer systems, a client and a server, are depicted according to embodiments of the present invention. Client 300 comprises processor 301, memory 302, and communications interface 303 and issues requests to a server. Server 304 comprises processor 305, memory 306, and communications interface 307. Server 304 satisfies requests received from the client. It will be understood that this illustration is only an example, and there may be many more client systems and many more server systems according to some embodiments of the present invention. Client system 300 issues a request using request router 311. Request router 311 determines which server (e.g., server 304) and which partition manager executed by processor 305 will handle this request and forwards the request to that partition manager as an inter-process message or as a network message transmitted between the communications interfaces 303 and 307 over the network interconnection 314. Processor 305 may execute partition managers 312 to manage one or more sub-tables 313 stored in memory 306.

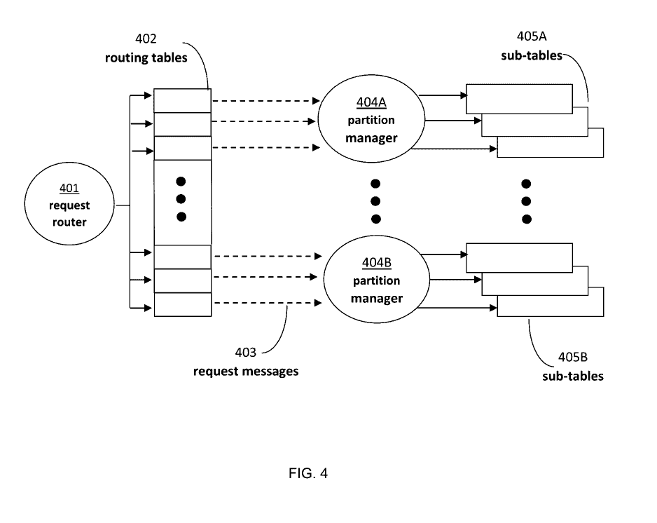

With regard to FIG. 4, a detailed illustration of an exemplary request router 401, partition managers 404A and 404B, and sub-tables 405A and 405B is depicted according to some embodiments of the present invention where request routers are on different computers or in different address spaces than partition managers. According to some embodiments, request router 401 and partition managers 404A and 404B are executed by distinct processors (e.g., processor 301 and 305), and routing table 402 contains one entry for each sub-table. The entry includes a message routing address to the partition manager that is currently assigned to serving the associated sub-table. The request router determines which sub-table (e.g., sub-tables 405A) a particular request belongs in, and uses the routing table 402 to look up the address of the responsible partition manager. The request router sends a request message to that partition manager (e.g., partition manager 404A). One familiar with the art will recognize there are numerous well-known ways to implement request protocols through inter-process and network messaging mechanisms. Generally a partition manager serves one or more sub-table, and at any given time, a particular sub-table is served by only one partition manager. This ensures the serialization of all operations within that sub-table. Where the partition managers operate in parallel, parallel operations are enabled in independent sub-tables.

Efficient Parallel Insertion into an Open Hash Table

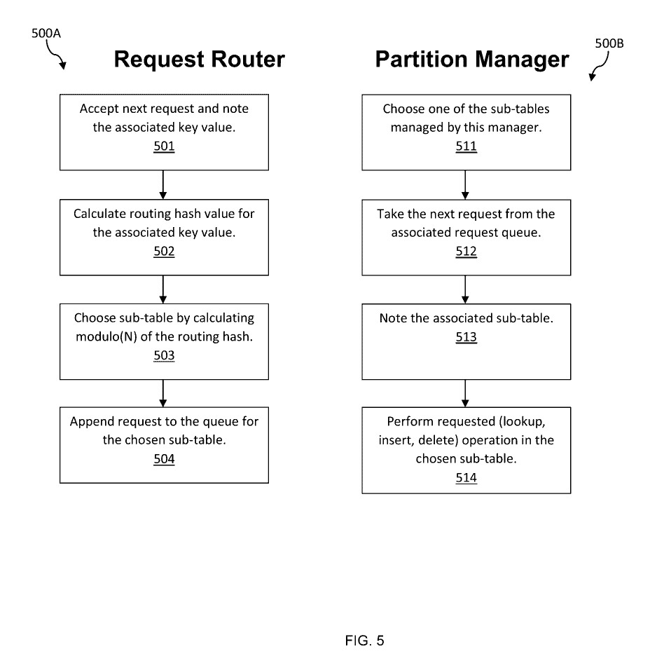

With regard to FIG. 5, a flow chart of an exemplary sequence of steps for distributing requests among multiple sub-tables using a request router and a partition manager is depicted according to embodiments of the present invention. Sequence 500A illustrate exemplary steps performed using a request router, and sequence 500B illustrates exemplary steps performed using a partition manager. At step 501, a next request is accepted by a request router and the associated key value is noted. The key value may comprise one or more values. A hash routing function is chosen to distribute requests well across the request queues. The most trivial routing hash function would be the sum the values in the key, but different applications impose different affinity, disaffinity, and distribution constraints on the mapping of requests to partition managers. One skilled in the art will understand the constraints of each particular problem and be able to design a routing hash function accordingly. At step 502, the routing hash value is calculated for the associated key value. However the routing hash function is computed, that value will be taken modulo the number of sub-tables at step 503, and the result will be the index of the sub-table to which this request should be routed. The request router will append that request to the end of a service queue (e.g., a service queue of service queues 202) for the chosen sub-table at step 504.

With regard still to FIG. 5, at step 511, the queue from which the next request should be taken is chosen from the list of queues being managed by the partition manager. In one embodiment of this invention, the queues are processed in round-robin order. In another embodiment of this invention, the partition manager processes some requests from each queue before moving on to the next queue. Once a queue has been chosen, a request is obtained at step 512. The partition manager notes which sub-table this request involves and the requested operation at step 513. At step 514, the specified operation is performed in the specified sub-table. One skilled in the art will be familiar with many open hash table algorithms. By benefit of the sub-table serialization provided by the partition manager, any such algorithm can be safely used, so long as all overflows remain within the chosen sub-table.

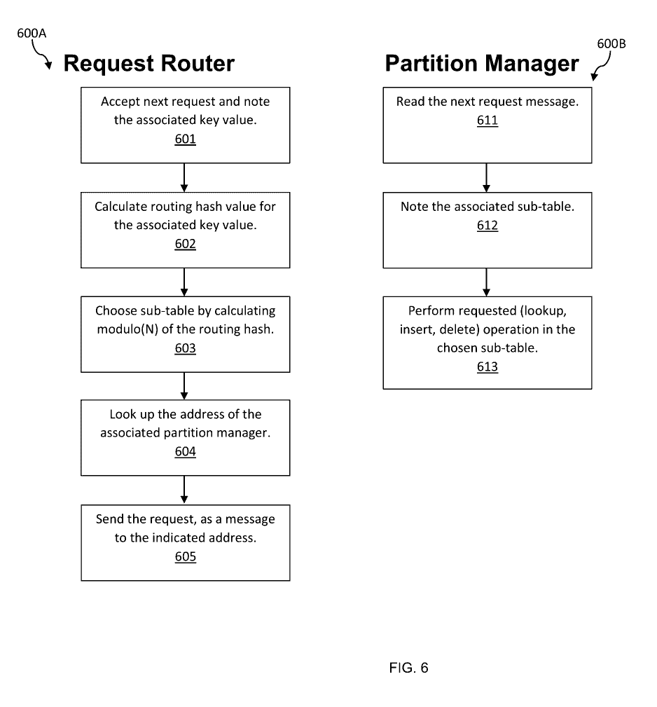

With regard to FIG. 6, a flowchart depicting an exemplary sequence of steps 600A and 600B for distributing requests to partition managers using a request router is depicted according to embodiments of the present invention. The routing hash function may be the same as described above. However, instead of having a queue associated with each sub-table and a configured queue list for each partition manager, there is a routing table (e.g., a global routing table) that contains the address of the partition manager associated with the sub-tables. The routing table may be consulted to find the address of the partition manager currently assigned to manage the chosen sub-table, and the request is sent as either an inter-process or network message to that address. This approach may be better suited to applications where the request router and partition manager do not share a single address space or file system. Sequence 600A illustrates exemplary steps performed using a request router, and sequence 600B illustrates exemplary steps performed using a partition manager. At step 601, a next request is accepted by the request router and the associated key value is noted. At step 602, a routing hash value is calculated for the associated key value. At step 603, a sub-table is determined by calculating modulo(N) of the routing hash. At step 604, an address of the associated partition manager is determined. At step 605, the request is sent as a message to indicate the address.

With regard still to FIG. 6, the partition managers may have a single input stream, and there is no need to choose from which queue the next message should be taken. The remainder of the request processing proceeds as described above. These techniques are an improvement over implementations that require expensive locks and add a great deal of overhead and complexity. The time and space overhead associated with these techniques are similar to that of implementations with uncontested locks. At step 611, the next request is read by the partition manager. At step 612, the associated sub-table is noted. At step 613, the request is performed (e.g., lookup, insert, delete) in the chosen sub-table.

### Performing Load Redistribution Using Partition Managers

While in some cases the association of sub-tables with partition managers is relatively static, according to some embodiment of the present invention, superior performance may be obtained by dynamically adjusting this association in response to changes in load and resources. As load increases, it may be desirable to add additional partition managers either within a single computer system, or by adding additional servers. When a new partition manager is added, some of the partitions currently managed by existing managers should be transferred to the new manager. If a partition manager becomes overloaded or fails, some or all of its partitions should be transferred to the surviving partition managers. For such transfers to work efficiently the number of sub-tables is significantly (e.g. 10x) greater than the maximum expected number of partition managers. If the number of sub-tables is not much larger than the number of partition managers, the achieved load distribution will likely be very uneven.

For some embodiments of this invention that forward requests to partition managers through queues, the reassignment of sub-tables to partition managers may be adjusted by updating the configured queue list. If all partition managers do not share a single address space, updates to the configured queue lists should be coordinated. One familiar with the art will be aware of multiple standard mechanisms for configuring application-specific parameters and notifying those applications of changes to their configuration.

For some embodiments of this invention that forward requests to partition managers via inter-process or network messages, the reassignment of sub-tables to partition managers can be adjusted by updating the routing table. If there are multiple client computer systems, the client computer systems have an identical copy of the routing table and/or the misdirected requests will be forwarded to the correct server. This is a fundamental requirement of some consistent placement schemes. One familiar with the art will recognize that there are numerous well-known content distribution and distributed consensus protocols for achieving this.

One way to distribute sub-tables among partition managers is by taking the sub-table number modulo the number of partition managers. However, one skilled in the art will recognize that this approach results in considerable reassignment whenever the number of partition managers changes. Much greater efficiency may be obtained by minimizing the reassignment. FIGS. 5, 6, and 7 illustrate exemplary reassignment minimizing approaches.

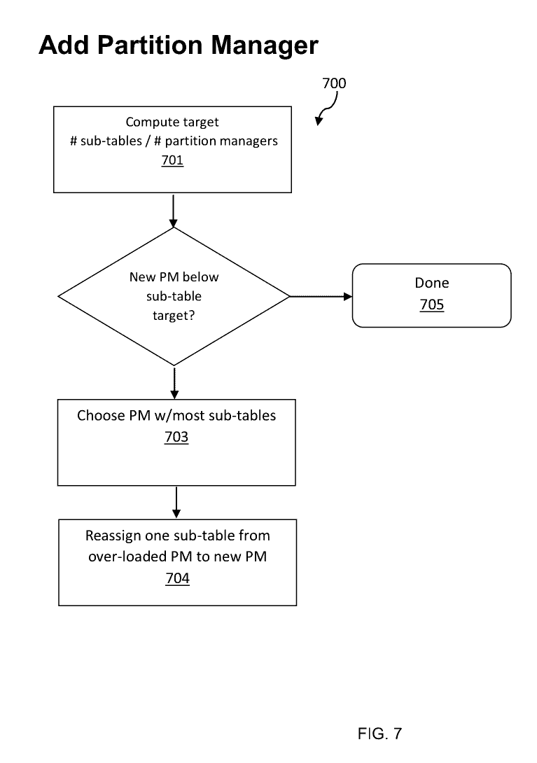

With regard to FIG. 7, a flow chart of an exemplary sequence of steps 700 for adding a partition manager is depicted according to embodiments of the present invention. When a new partition manager is added, a target number of sub-tables is computed at step 701. That target is the total number of sub-tables divided by the new total number of partition managers (including the newly added one). It is determined if the new partition manager has been brought up to that target at step 702. If not, the partition manager that currently has the greatest number of sub-tables (e.g., a heavy partition manager) is found at step 703. One of the sub-tables is transferred to the new partition at step 704. According to some embodiments, this is accomplished by updating the corresponding entries in the configured queue list (e.g., configured queue list 203) or routing table. If the new partition manager has been brought up to that target at step 702, the process ends at step 705.

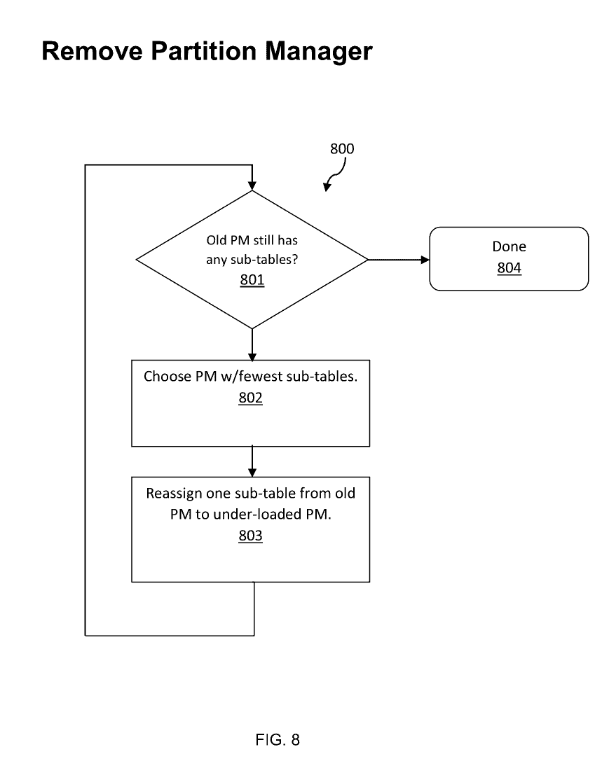

With regard to FIG. 8, a flow chart depicting an exemplary sequence of steps 800 for redistributing sub-tables in response to a failure or shut-down of a partition manager is depicted according to embodiments of the present invention. At step 801, it is determined if there are still sub-tables associated with the partition manager that is being removed. If so, at step 802, the partition manager that currently has the smallest number of sub-tables (e.g., a light partition manager) is found. At step 803, a sub-table from the partition manager that is being removed is transferred to the light partition manager. According to some embodiments, this is accomplished by updating the corresponding entries in the configured queue list (e.g., configured queue list 203) or routing table. If there are no more sub-tables associated with the partition manager that is being removed at step 801, the process ends at step 804. Otherwise, the process returns to Step 801 and the sequence of steps 800 is repeated until there are no more sub-tables associated with the partition manager that is being removed. Similar approaches can be used to redistribute sub-tables in response to load imbalances. In most cases, such imbalances result from weakness in the chosen routing hash algorithm.

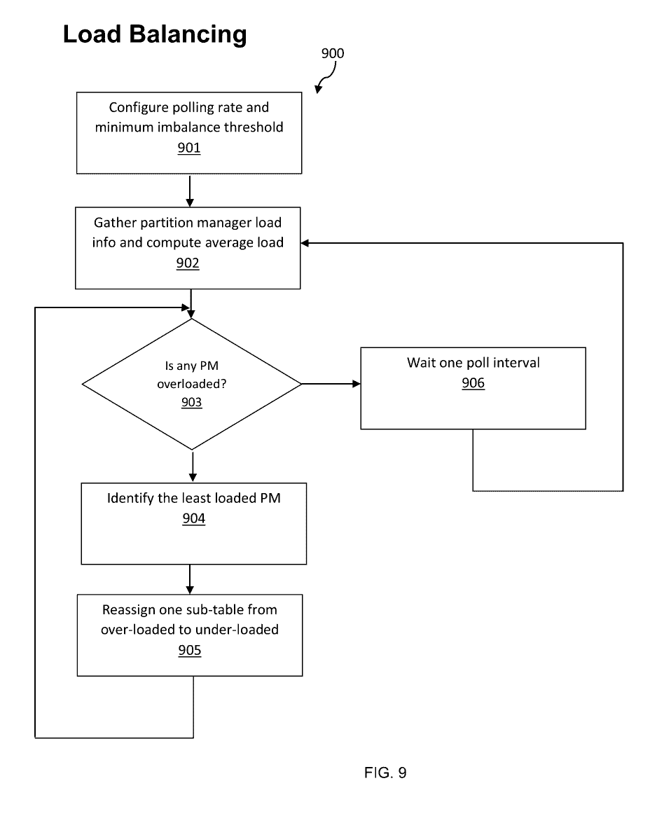

With regard to FIG. 9, an exemplary sequence of steps 900 for performing automatic load balancing using an open hash table is depicted according to embodiments of the present invention. At step 901, a polling rate and minimum imbalance threshold are configured. The system will periodically gather load information from the partition managers and compute the average load at step 902. The system will then compare the load on the partition managers with that average to see if it is overloaded beyond the configured minimum imbalance threshold at step 903. If so, the system will identify the least loaded partition manager at step 904, and transfer one sub-table from the most-overloaded partition manager to the least loaded partition manager at step 905. The process then returns to step 903. If the partition managers are not overloaded beyond the configured minimum imbalance threshold at step 903, the process waits for one poll interval before returning to step 902.

One skilled in the art will recognize that it is critical to avoid oscillations in a feedback network. Two critical parameters are chosen at step 901: a polling rate (used in step 906), and a minimum imbalance threshold (used in step 903). If the polling rate is too fast subsequent changes will be made before the system has reached a new equilibrium from the previous changes. If the imbalance threshold is set to be too low, the system will constantly be redistributing load and never reach an equilibrium. Ideal values will make the system responsive while avoiding wasteful oscillations, and are usually found through measurement and tuning.

Embodiments of the present invention are thus described. While the present invention has been described in particular embodiments, it should be appreciated that the present invention should not be construed as limited by such embodiments, but rather construed according to the following claims.

What is claimed is:

1. An apparatus for servicing an incoming request to an open hash table, the apparatus comprising:
a memory for storing a plurality of sub-tables; and
a processor coupled to the memory that receives the incoming request which includes a key value to perform a first action in a first sub-table, calculates a routing hash value associated with the key value using a hash function, determines an index for the routing hash value by calculating a modulo (N) function of the routing hash value, and appends the incoming request to a queue associated with the first sub-table, wherein N is a number of sub-tables associated with the processor, the index corresponds to the first sub-table, and the processor is operable to retrieve the incoming request from the queue to perform the first action.

2. The apparatus of claim 1, wherein the first action requested by the incoming request comprises at least one of a lookup, insert, and delete operation.

3. The apparatus of claim 1, wherein the sub-tables are accessed in parallel.

4. The apparatus of claim 1, wherein each sub-table has a dedicated queue.

5. The apparatus of claim 1, wherein incoming requests are serviced in a round-robin order.

6. The apparatus of claim 1, wherein the incoming request is sent as an inter-process message.

7. The apparatus of claim 1, wherein the incoming request is sent as a network message.

8. The apparatus of claim 1, wherein the hash function performs a polynomial function on the key value.

9. The apparatus of claim 1, wherein the hash function performs a logical function on the key value.

10. In a data storage system, a method of servicing an incoming request to an open hash table, the method comprising:
receiving the incoming request comprising a key value;
calculating a routing hash value associated with the key value using a hash function;
determining an index for the routing hash value by calculating a modulo (N) function of the routing hash value, wherein N is a number of sub-tables associated with the request router and the index corresponds to a sub-table;
appending the incoming request to a service queue associated with the sub-table;
retrieving the incoming request from the service queue; and
performing an operation requested by the incoming request in the sub-table.

11. The method of claim 10, wherein the operation requested by the incoming request comprises at least one of a lookup, insert, and delete operation.

12. The method of claim 10, wherein the key value comprises a plurality of values and the hash function comprises summing the plurality of values.

13. The method of claim 10, wherein the operation is performed in parallel with a second operation performed on a second sub-table.

14. The method of claim 10, wherein the sub-table has a dedicated queue.

15. The method of claim 10, wherein incoming requests are serviced in a round-robin order.

16. The apparatus of claim 10, wherein the incoming request is sent as an inter-process message.

17. The apparatus of claim 10, wherein the incoming request is sent as a network message.

18. The apparatus of claim 10, wherein the hash function performs a polynomial function on the key value.

19. The apparatus of claim 10, wherein the hash function performs a logical function on the key value.

20. The apparatus of claim 10, wherein the incoming request is sent using a message queue.
